(19) United States
(12) Patent Application Publication
(10) Pub. No.: US 2014/0101130 A1
(43) Pub. Date: Apr. 10, 2014

(54) JOIN TYPE FOR OPTIMIZING DATABASE QUERIES

(71) Applicant: TIBERO CO., LTD., Gyeonggi-do (KR)

(72) Inventors: BongChae KANG, Gyeonggi-do (KR); Sang Young PARK, Gyeonggi-do (KR); Sukwon YI, Gyeonggi-do (KR); Youngjae CHOI, Gyeonggi-do (KR)

(73) Assignee: TIBERO CO., LTD., Gyeonggi-do (KR)

(21) Appl. No.: 13/741,522

(22) Filed: Jan. 15, 2013

(30) Foreign Application Priority Data
Oct. 10, 2012 (KR) 10-2012-00112507

(51) Int. Cl. G06F 17/30

(52) U.S. Cl. CPC G06F 17/30466
USPC 707/714

(57) ABSTRACT

A query complier analyzes a query to identify a correlated scalar subquery. The query complier transforms the query having the correlated scalar subquery into a query of AGGREGATION INNER/OUTER JOIN or MAX1ROW INNER/OUTER JOIN depending on a result type of the correlated scalar subquery. The AGGREGATION INNER/OUTER JOIN performs JOIN on the rows of the correlated scalar subquery with the rows of a main query and AGGREGATE on the joined rows and returns a result of the joined rows of the main query and aggregation value thereof. The MAX1ROW INNER/OUTER JOIN performs JOIN on the rows of the correlated scalar subquery with the rows of a main query, raises Error when the number of joined rows of the subquery is two or more and returns a result of the row of the main query and the joined row of the subquery.

### FIELD OF THE INVENTION

The present invention relates to a query compiler for use in a database management system, and more particularly, to a query compiler and a method for optimizing database queries.

Support for the present invention was provided by the Ministry of Knowledge Economy in Korea under Project 10040824 [Source Technology Development Business for Industrial Convergence].

### BACKGROUND OF THE INVENTION

Generally, a database stores data with correlation, and the data stored in the database are needed to be updated, inserted, and deleted. Thus, the database is managed by a software system called a database management system (DBMS). The DBMS is an integrated data management system that allows application programs to search or change desired data so as to provide consistent results to the application programs at all times.

In order to fetch the data stored in the database, a query is written using a query language called a structured query language (SQL). An operation for converting an SQL query to a query execution plan that can be conducted in the database is executed by a query compiler. The query execution plan is comprised of a tree having nodes of operations required to execute a query.

In an actual query compiler, the procedure of converting an SQL query to a query execution plan is performed as follows.

First, a query is parsed to form a parse tree structure. Next, a query rewrite process is performed to transform the parse tree to a more general form of the parse tree. Next, the transformed parse tree is again transformed to an execution plan having a minimum cost based on statistic information.

Of course, a result may be correctly obtained even without any query rewriting process. Making the parse tree into a more general form by the query rewriting is to make more execution plans, which results in raising the possibility to obtain the more optimized execution plan.

Further, the query rewriting may also be used to remove portions that are included in the original query but that need not to be operated, thereby improving the performance of the query compiler as well as query execution.

Therefore, it is strongly desired to rewrite the queries so that the optimized execution plans can be established in the query compiler.

### SUMMARY OF THE INVENTION

In view of the above, the present invention provides a method used by a query complier.

In accordance with a first aspect of the present invention, there is provided a method for optimizing database queries, which includes: searching a subquery within a query; analyzing the searched subquery to identify a candidate of a scalar subquery; analyzing the candidate scalar subquery to identify a candidate of a correlated scalar subquery; and transforming the query having the candidate correlated scalar subquery into a query of a quasi-JOIN according to a result type of the candidate correlated scalar subquery.

In the method, the analyzing the searched subquery includes: analyzing whether the searched subquery is written along with a comparison operator while being included in WHERE clause to identify the searched subquery as the candidate scalar subquery.

In the method, the analyzing the searched subquery includes: analyzing whether the searched subquery is included in SELECT clause to identify the searched subquery as the candidate scalar subquery.

In the method, the analyzing the candidate scalar subquery includes: analyzing whether the candidate scalar subquery uses a column included in a table of the main query to identify the candidate scalar subquery as the candidate correlated scalar subquery.

In the method, the transforming the query having the candidate correlated scalar subquery into a query of a quasi-JOIN includes: performing UNNEST on the query having the candidate correlated scalar subquery to create a query of AGGREGATION INNER/OUTER JOIN when the candidate correlated scalar subquery takes a type of returning a result of AGGREGATION.

In the method, the transforming the query having the candidate correlated scalar subquery into a query of a quasi-JOIN includes: performing UNNEST on the query having the candidate correlated scalar subquery to create a query of MAX1ROW INNER/OUTER JOIN when the candidate correlated scalar subquery takes a type of returning one column value.

In the method, the AGGREGATION INNER/OUTER JOIN functions to perform JOIN on the rows of the correlated scalar subquery with the rows of a main query and AGGREGATE on the joined rows and returns a result of the joined rows of the main query and aggregation value thereof.

In the method, the MAX1ROW INNER/OUTER JOIN functions to perform JOIN on the rows of the correlated scalar subquery with the rows of a main query, raises Error when the number of the joined rows of the subquery is two or more and returns a result of the row of the main query and the joined row of the subquery.

In the method, the quasi-JOIN conditionally processes the joined rows for a left row by an event type.

In the method, the quasi-JOIN is implemented by join algorithms having HASH JOIN, MERGE JOIN and NESTED LOOP JOIN.

In accordance with a second aspect of the present invention, there is provided a query compiler, which includes: a parser configured to parse a query provided to the query compiler; a query rewriter configured to analyze the parsed query to identify a correlated scalar subquery and transform the query having the identified correlated scalar subquery into a query of a quasi-JOIN according to a result type of the identified correlated scalar subquery; and a query optimizer configured to make a plurality of execution plans from the transformed query of a quasi-JOIN using statistical information, and select a query execution plan having a minimum cost among the plurality of execution plans.

In the query complier, the query rewriter identifies a scalar subquery included in SELECT clause, and the query rewriter identifies a scalar subquery written along with a comparison operator in the subquery while being included in WHERE clause. The query rewriter also identifies a scalar subquery using a column included in a table of the main query as the correlated scalar subquery.

In the query complier, the query rewriter performs UNNEST on the query having the correlated scalar subquery to create a query of AGGREGATION INNER/OUTER JOIN when the correlated scalar subquery takes a type of returning a result of AGGREGATION. Further, the query rewriter performs UNNEST on the query having the correlated scalar subquery to create a query of MAX1ROW INNER/OUTER JOIN when the correlated scalar subquery takes a type of returning one column value.

In the query complier, the AGGREGATION INNER/OUTER JOIN functions to perform JOIN on the rows of the correlated scalar subquery with the rows of a main query, AGGREGATE on the joined rows and returns a result of the joined rows of the main query and aggregation value thereof.

In the query complier, the MAX1ROW INNER/OUTER JOIN functions to perform JOIN on the rows of the correlated scalar subquery with the rows of a main query, raises Error when the number of joined rows of the subquery is two or more and returns a result of the row of the main query and the joined row of the subquery.

In the query complier, the quasi-JOIN is implemented by join algorithms having HASH JOIN, MERGE JOIN and NESTED LOOP JOIN.

In accordance with a third aspect of the present invention, there is provided a method for optimizing database queries, which includes: analyzing a query to identify INLINE VIEW; and transforming the query having the identified INLINE VIEW into a query of AGGREGATION INNER/OUTER JOIN when a main table and the result of INLINE VIEW are joined at N:1 or 1:1, wherein the AGGREGATION INNER/OUTER JOIN functions to perform JOIN on the rows of the result of INLINE VIEW without aggregation, AGGREGATE on the joined rows and returns a result of the joined rows of the main table and aggregation value thereof.

In accordance with a fourth aspect of the present invention, there is provided a method for optimizing database queries, which includes: analyzing a query to identify GROUP BY with AGGREGATION; and when JOIN is below the GROUP BY with AGGREGATION, all of the key columns in a main table is used as keys of GROUP BY, and columns in other table do not participate as a key of GROUP BY, transforming the query having the identified GROUP BY with AGGREGATION into a query of AGGREGATION INNER/OUTER JOIN, wherein the AGGREGATION INNER/OUTER JOIN functions to perform JOIN on the rows of the other table, AGGREGATE on the joined rows and returns a result of the joined rows of the main table and aggregation value thereof.

### BRIEF DESCRIPTION OF THE DRAWINGS

The above and other objects and features of the present invention will become apparent from the following description of embodiments given in conjunction with the accompanying drawings, in which:

FIG. 1 illustrates a block diagram of a query compiler used in a database management system to which the present invention is applied;

FIG. 2 shows a flow chart for a method of optimizing queries in accordance with an embodiment of the present invention;

FIGS. 3A and 3B illustrate a procedure of performing UNNESTING on main queries each having a correlated scalar subqueries by AGGREGATION INNER/OUTER JOIN, in accordance with the embodiment of the present invention;

FIGS. 4A and 4B illustrate a procedure of performing UNNESTING on main queries each having a correlated scalar subqueries by MAX1ROW INNER/OUTER JOIN, in accordance with the embodiment of the present invention; and

FIGS. 5A and 5B illustrate a procedure of performing UNNESTING on INLINE VIEW subquery other than the correlated scalar subqueries by AGGREGATION JOIN, in accordance with the embodiment of the present invention.

### DETAILED DESCRIPTION OF THE EMBODIMENTS

Hereinafter, embodiments of the present invention will be described in detail with reference to the accompanying drawings.

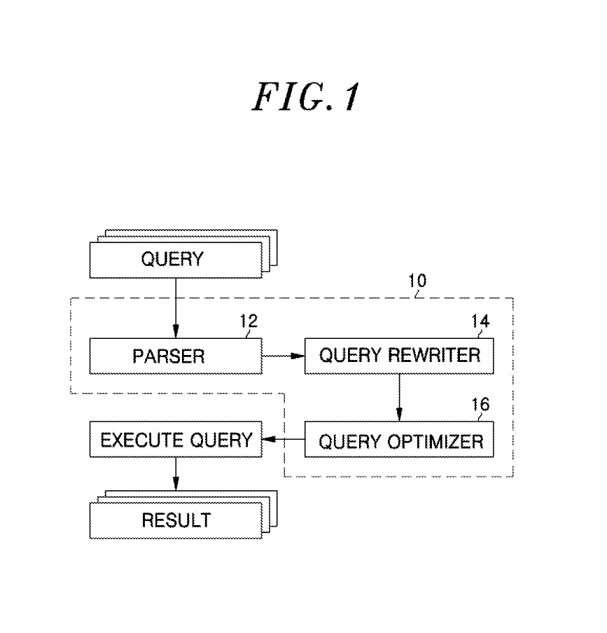

FIG. 1 illustrates a block diagram of a query compiler 10 that is used in a database management system to which the present invention is applied. The query compiler 10 includes a parser 12, a query rewriter 14, and a query optimizer 16.

The parser 12 parses an SQL query provided to the query compiler 10 to form a structure such as a parse tree. During a parsing process, it is confirmed whether the query has a grammatical error and a semantic error, and the parsing process then proceeds to a query rewrite process. The query rewriter 14 makes a query having the parse tree structure more general to allow the query optimizer 16 to yield more query execution plans. The query optimizer 16 utilizes statistical information to generate a plurality of query execution plans from the rewritten query (revised parse tree) and selects a query execution plan having a minimum cost and optimized efficiency among the query execution plans. The query is executed according to the optimized execution plan generated and selected by the query optimizer 16 to return the executed results.

As set forth above, it is preferred that the query rewriter 14 is configured to make the query into a more general type so as to yield more query execution plans and remove parts of the query that are not need to be operated.

Among others, several representative query rewritings will be listed below.

1. Outer Join Simplification

This operation is to change OUTER JOIN into INNER JOIN if OUTER JOIN can be performed as INNER JOIN rather than OUTER JOIN due to schema information or conditions written in WHERE clause even though OUTER JOIN is within a query.

2. Simple View Merging

This operation removes VIEW used in a query and merges the query into an upper query block or a main query.

3. Expression Rewriting

When an expression included in a query is simply executable in advance or is complicated to take much time to execute, this operation changes the query to get a simple expression.

4. Subquery Unnesting

The operation unnests a subquery included in a query and merges the query into an upper query block, such that hierarchical structures between the query and the subquery have the same level.

Among the foregoing query rewriting operations, the Subquery Unnesting disclosed in No. 4 is related to the embodiments of the present invention.

The subquery which may be unnested by the Subquery Unnesting operation may be sorted into four types of subquery as follows.

4-1. Uncorrelated Scalar Subquery

This subquery returns only one row, without referring COLUMN from an upper query block. For example, the subquery may include a subquery written as follows.

select emp_no from emp
where salary = (select max (salary) from emp)

4-2. Uncorrelated Non-Scalar Subquery

This subquery is a subquery returning multiple rows as a subquery result, without referring COLUMN from an upper query block. An example of this subquery may include a subquery written as follows.

select emp_no from emp
where dept_code in

(select dept_code from dept where company =

‘tibero’)

4-3. Correlated Scalar Subquery

This subquery is a subquery which refers COLUMN from a main query and returns only row. An example of the subquery may include a subquery written as follows.

select emp_no from emp m
where salary = (select max (salary) from emp s

where s.dept_code = m.dept_code)

4-4 Correlated Non-Scalar Subquery

This subquery is a subquery which refers COLUMN from a main query and returns multiple rows as a subquery result. An example of the subquery may include a subquery written as follows.

select emp_no from emp m
where sold_item in (select sold_item from item s

where s.htd > m.speciality)

Among the foregoing four subqueries, the uncorrelated scalar subquery has the same result value at all times, and therefore, needs not to be unnested. Meanwhile, the subqueries described in Nos. 4-2 to 4-4 are needed to be unnested.

The uncorrelated non-scalar subquery described in No. 4-2 is uncorrelated and thus, it looks like no need to perform a subquery unnesting; however, when a size of a table in the subquery is increased, it is always preferable to perform the subquery unnesting since the rows of subquery result must be compared to each row of a main query.

Meanwhile, the subqueries described in Nos. 4-3 and 4-4 are correlated subqueries and therefore, these subqueries need to be executed for each row of a main query. Accordingly, it is always preferable for these subqueries to perform the subquery unnesting.

Following is a description of four separate methods of processing an exemplary main query including a correlated scalar subquery, where the exemplary query represents to choose an employee who gets a maximum annual salary for his/her own department.

select emp_name
from emp m
where salary = (select max (salary)

from emp s
where m.dept_code = s.dept_code)

A first method does not perform a subquery unnesting on the scalar subquery within the main query. This method applies a correlated value to the scalar subquery in ROW by ROW and processes the scalar subquery in order to generate scalar value to be used in filter expression.

A second method is to rewrite the query as follows.

select emp_name
from emp m,

(select dept_code, max (salary) maxsalary
from emp group by dept_code) s

where m.dept_code=s.dept_code and m.salary=s.maxsalary

That is, the second method performs GROUP BY and AGGREGATION in INLINE VIEW and then JOIN with the outer table as set forth above.

A third method is to add ROWID as a key for row in a main query and perform GROUP BY after JOIN. This method is represented by the SQL query as follows.

select emp_name
from (select m.emp_name, m.salary, max (s.salary)

maxsalary

from emp m, emp s
where m.dept_code = s.dept_code
group by m.rowid, m.emp_name, m.salary)
where salary = maxsalary

The first method may be performed quickly by using a query cache of the scalar subquery when the number of departments is small. However, in the reverse case, the first method may have a disadvantage because subquery must be computed repeatedly as much as the number of departments.

The second method executes GROUP BY only once and then JOIN irrelevant to the number of departments (when using HASH JOIN). Therefore, the second method may be superior over the first method in speed when the number of departments is large. Meanwhile, when DISTINCT COUNT of correlated values is small, the second method may process the subquery using NESTED LOOP type and thus may be superior over the first method. However, the second method may have a disadvantage in that the same value is calculated again due to the absence of query cache and is difficult to discuss merits and demerits when using HASH JOIN. However, this method additionally performs grouping operation, and thus, has a disadvantage in that the memory is needed more and the processing time takes longer.

The third method is superior over the second method when the amount of grouping operation reduced by JOIN is large, and otherwise, greatly increases amount of grouping operation that is output as a result in JOIN as compared with the second method and thus, may not be good. Further, the third method also additionally performs grouping operation.

When the subquery result returns a column value but may produce multiple rows, the subquery may be shown like a query below.

select emp_name,

(select dept_name from dept s
where m.dept_code = s.dept_code)

from emp m

For the SQL as set forth above, one subquery result per one row in the main query must come out, but when the subquery is unnested by the first to third methods, it is impossible to properly raise an error on the case when the subquery comes out one or more results. Therefore, the subquery cannot be unnested, and the execution operation for the subquery may be increased.

The inventors have tried numerous and repetitive executions with new JOIN type which enables JOIN algorithm (including NESTED LOOP, HASH, MERGE) to cover the first and second methods and shifts works to be processed at several nodes to JOIN node, by which the execution time can be reduced by internally using a cache and shortcut.

In the embodiments of the present invention, the query compiler 10 searches one or more subqueries in a query input by the user, identifies scalar subqueries from the searched subqueries, analyzes the identified scalar subqueries to identify a correlated scalar subquery, and converts the query having the correlated scalar subquery identified into a new query performing corresponding JOIN operation.

Herein, the term of a new JOIN refers a JOIN method newly proposed by the inventors that cannot be represented as an ordinary syntax of SQL. The new JOIN includes AGGREGATION (INNER/OUTER) JOIN and MAX1ROW (INNER/OUTER) JOIN. For convenience and proper representation, the new JOIN may be referred to as a quasi-JOIN in the embodiments.

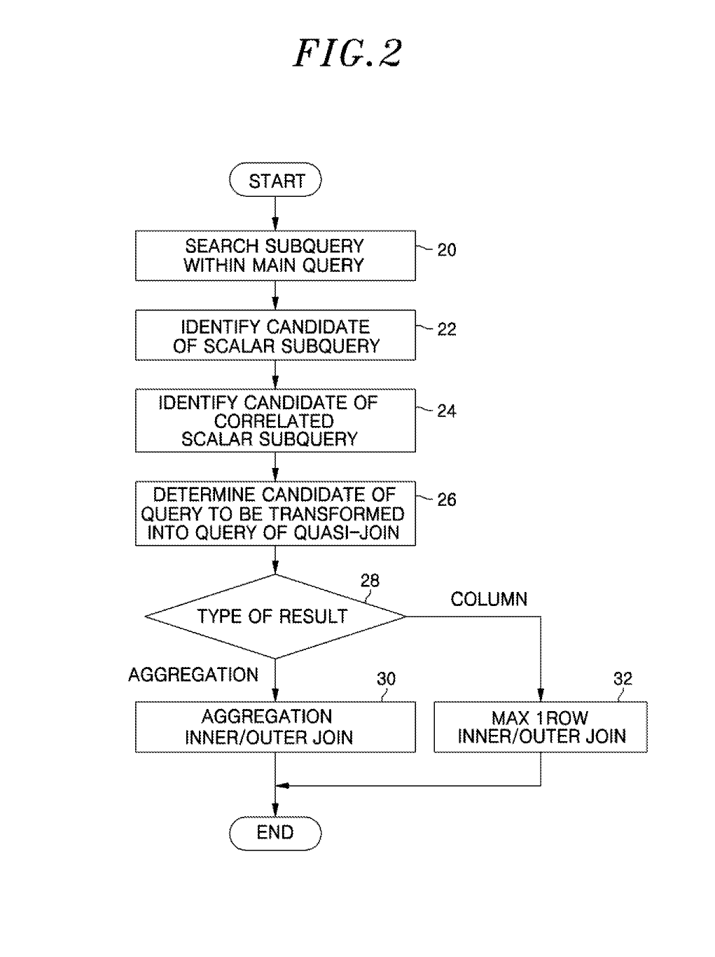

Hereinafter, a method for optimizing database queries performed by the query compiler 10 will be described with reference to FIG. 2.

First, in operation 20, the query compiler 10 analyzes an SQL query to search the presence of a candidate subquery within a main query.

In operation 22, the query complier 10 analyzes the searched subquery to identify whether or not the searched subquery is a candidate of a scalar subquery. The query complier 10 may identify the searched subquery as the candidate scalar subquery when the searched subquery is written along with a comparison operator (=, > and the like) rather than a SET operator such as IN or EXIST while being included in WHERE clause or a subquery included in SELECT clause.

In operation 24, the query complier 10 analyzes the candidate scalar subquery to identify whether or not the candidate scalar subquery is a candidate of a correlated scalar subquery. The query compiler 10 may identify the scalar subquery as the correlated scalar subquery when the scalar subquery uses a column included in a table of a main query.

In operation 26, the query having the candidate correlated scalar subquery is determined as a candidate query and transformed into a query of quasi-JOIN.

The quasi-JOIN includes AGGREGATION (INNER/OUTER) JOIN and MAX1ROW (INNER/OUTER) JOIN, which are sorted depending on the result types of the correlated scalar subquery, i.e., AGGREGATION or COLUMN.

In operation 28, in a case that the candidate correlated scalar subquery has a type of returning a result of AGGREGATION, the method advances to operation 30 where the query compiler 10 performs UNNEST on the candidate query to create AGGREGATION INNER/OUTER JOIN

Herein, the AGGREGATION INNER/OUTER JOIN functions to perform JOIN on the rows of the correlated scalar subquery with the rows of the main query, AGGREGATE on the joined rows and return a result of the joined rows of the main query and aggregation value thereof.

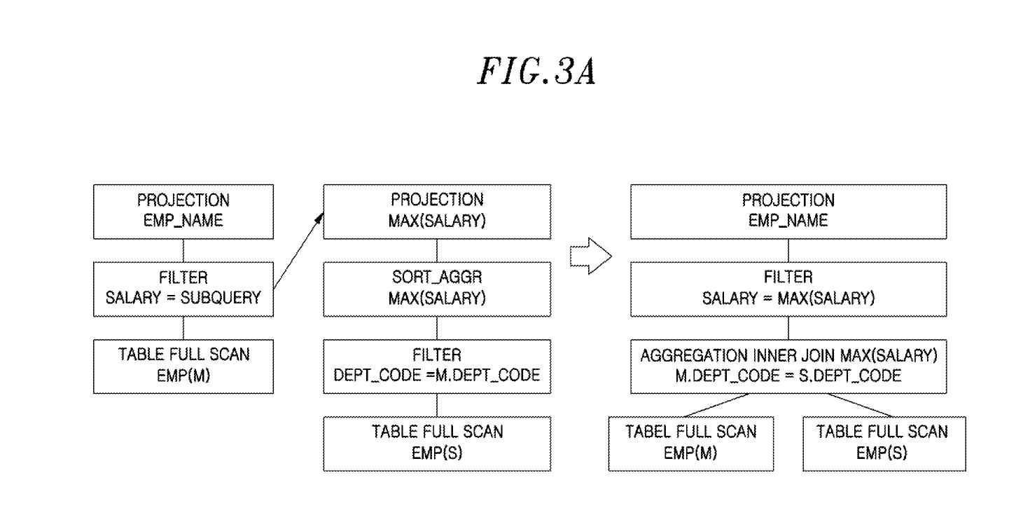

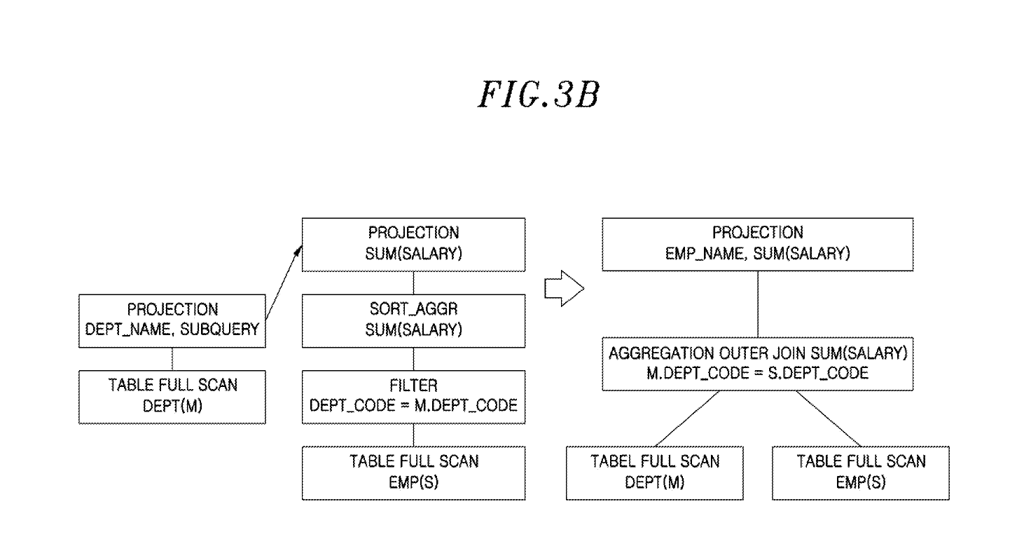

FIG. 3A illustrates, for example, a procedure of performing UNNEST on a candidate query having the following correlated scalar subquery to create a query of AGGREGATION INNER JOIN. Herein, the candidate query represents a query that outputs an employee that gets a maximum annual salary in his/her own department.

select emp_name
from emp m
where salary = (select max (salary)

from emp s
where m.dept_c_code = s.dept_code)

FIG. 3B illustrates, for example, a procedure of performing UNNEST on a candidate query having the following correlated scalar subquery to create a query of AGGREGATION OUTER JOIN. Herein, the candidate query represents a query that outputs a sum of annual salaries for each department.

select dept_name

(select sum (salary)
from emp s
where m.dept_code = s.dept_code)

from dept m

Meanwhile, in operation 28, in a case that the candidate correlated scalar subquery has a type of returning one column value, the method advances to operation 32 where the query compiler 10 performs UNNEST on the candidate query to create a query of MAX1ROW INNER/OUTER JOIN. Herein, the MAX1ROW INNER/OUTER JOIN functions to perform JOIN on the rows of the subquery with the rows of the main query, raises ERROR when the joined rows of the subquery is two or more and returns a result of the rows of the main query and the joined rows of the subquery.

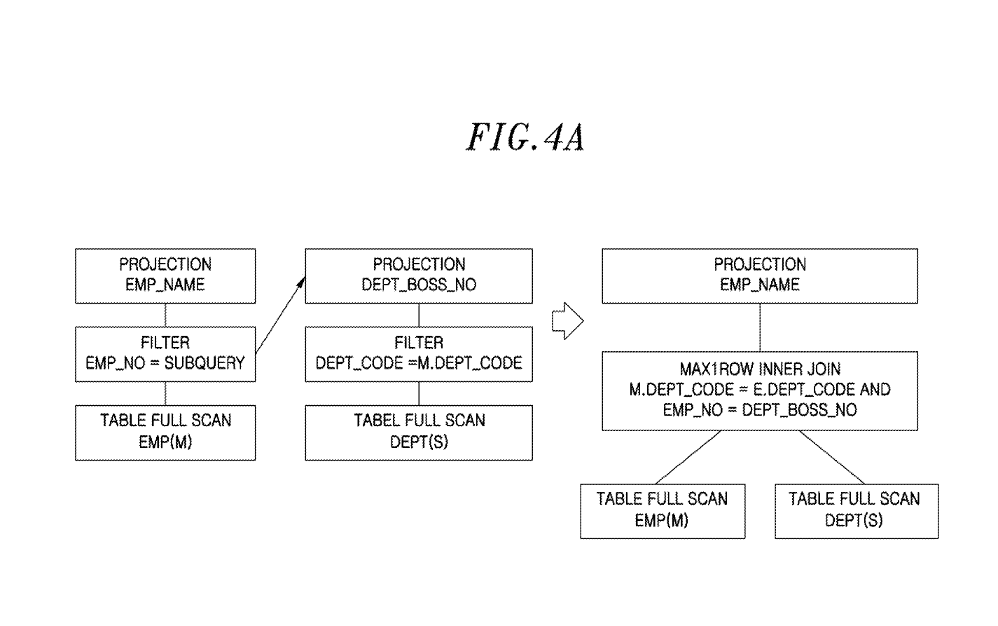

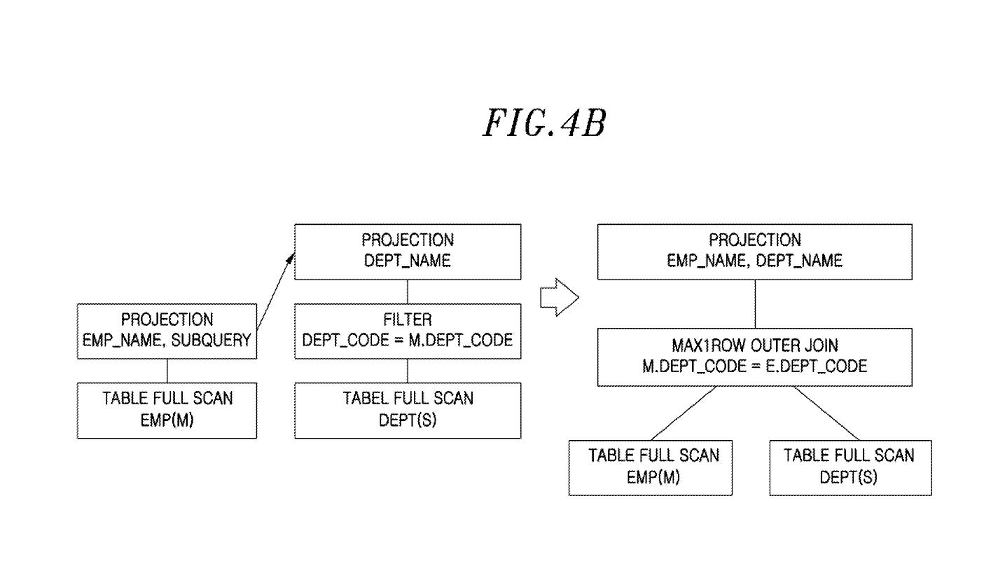

FIG. 4A illustrates, for example, a procedure of performing UNNEST on a candidate query having the following correlated scalar subquery to create a query of MAX1ROW INNER JOIN. Herein, the candidate query represents a query that outputs a name of each department manager.

select emp_name
from emp m
where emp_no =
(select dept_boss_no
from dept s
where m.dept_code = s.dept_code)

FIG. 4B illustrates, for example, a procedure of performing UNNEST on a candidate query having the following correlated scalar subquery to create a query of MAX1ROW OUTER JOIN. Herein, the candidate query is a query that outputs a name of an employee and a name of a department belonging to the employee.

select emp_name,
(select dept_name from depts.
where e.dept_code = d.dept_code)

from emp m

.

When the quasi-JOIN is actually executed by the query compiler 10, the candidate query having the candidate correlated scalar subquery is then transformed so as to be operated as JOIN.

The AGGREGATION JOIN of the quasi-JOIN supports three fundamental JOIN algorithms including Hash Join, NESTED LOOP JOIN, and MERGE JOIN and returns a result of AGGREGATION of left rows and joined right rows.

Meanwhile, the MAX1ROW JOIN clause of the quasi-JOIN also supports three fundamental JOIN algorithms including HASH JOIN, NESTED LOOP JOIN, and MERGE JOIN and has a difference in that Error occurred when the joined rows of the subquery are two or more for a corresponding row of the main query.

The foregoing embodiments have described a method for transforming the main query having the correlated scalar subquery into a query of quasi-JOIN. However, the query containing INLINE VIEW and some other types of query may be transformed into the quasi-JOIN scheme in accordance with the embodiment of the present invention. The other types of query are those included in queries that are described in the second and third methods above. These queries take a type that returns the same result as the query having the correlated scalar subquery and therefore, AGGREGATION JOIN may be applied these queries.

More specifically, for the second method above, when a table for Join operation is actually an INLINE VIEW statement that corresponds to GROUP BY with AGGREGATION, if the query satisfies the condition that another table and View are joined at N:1 or 1:1 by JOIN predicates that do not contain AGGREGATION, the candidate query can be converted into AGGREGATION JOIN of the quasi-JOIN by removing GROUP BY with AGGREGATION. As a result, it means that JOIN operation is combined with GROUP BY with AGGREGATION to become AGGREGATION JOIN. Herein, “another table and VIEW are joined at N:1” means that for each row in the other table, only one row of the view is joined, but this row of the view can be joined with multiple rows of the other table.

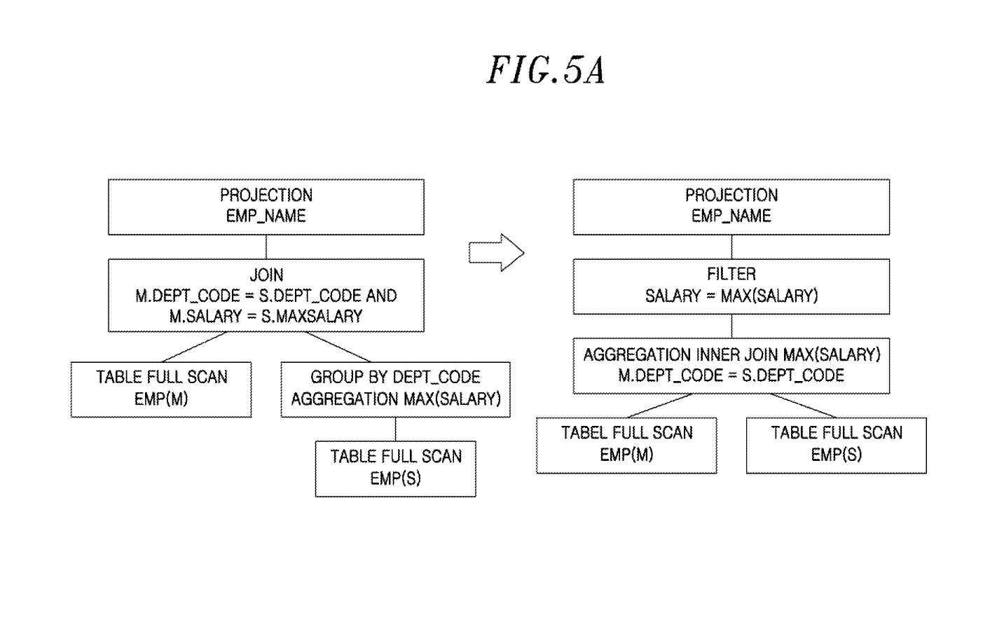

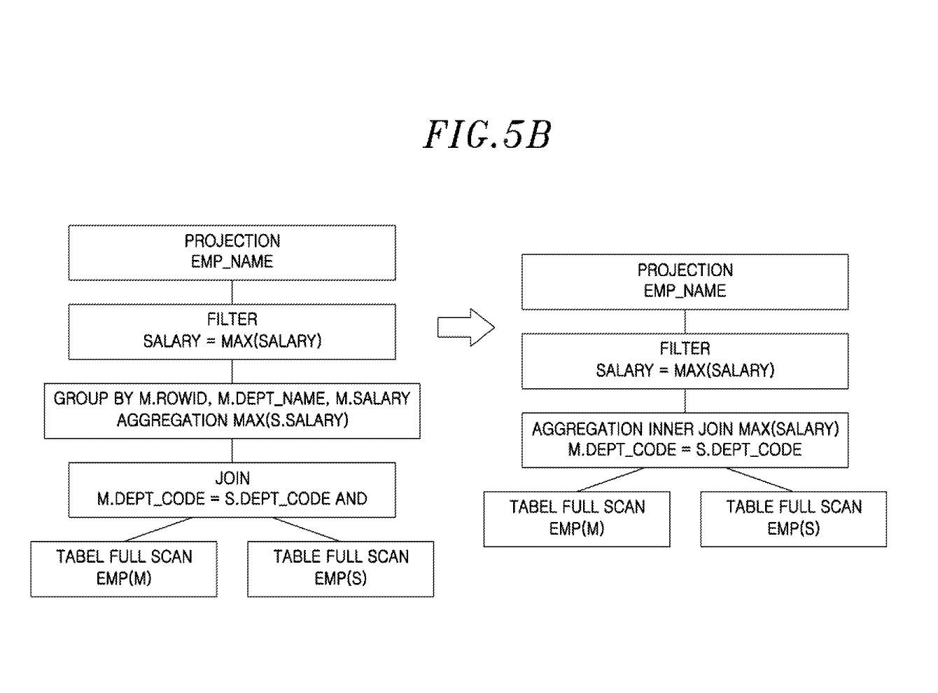

FIG. 5A illustrates, for example, a procedure of rewriting a candidate query having GROUP BY with AGGREGATION to create AGGREGATION JOIN. Herein, the candidate query represents a query that outputs an employee that gets a maximum annual salary in his/her own department.

select emp_name
from emp m,

(select dept_code, max (salary) maxsalary
from emp group by dept_code) s

where m.dept_code=s.dept_code and m.salary =

s.maxsalary

Meanwhile, for the third method above, the query has GROUP BY with AGGREGATION above JOIN clause. In this case, key columns of GROUP BY include key columns (a unique combination of columns in which the composite values of the column(s) of a row is not duplicated with other rows in the table) of one table and columns in the other table do not participate as a key of GROUP BY. The next query also represents a query that outputs an employee that gets a maximum annual salary in his/her own department.

select emp_name from (select m.emp_name, m.salary, max

(s.salary) maxsalary

from emp m, emp s
where m.dept_code = s.dept_code group by m.rowid,

m.emp_name, m.salary)

where salary = maxsalary

As can be appreciated from the above query, m and s are joined, and rowid, emp_name, dept_code, salary of m are then grouped. The rowid is a unique value in emp m and emp s is only referenced in aggregation and not in GROUP BY clause, thereby creating AGGREGATION JOIN.

FIG. 5B illustrates a procedure of rewriting the foregoing query to create a query of AGGREGATION JOIN.

Therefore, as described above, the execution speed of the query may be improved by converting the correlated scalar subquery included in the query into the join type.

As set forth above, it is possible to increase a possibility of making more execution plans by converting correlated scalar subqueries included in a query into a join type as compared with the related art and improve an execution speed of a query.

While the invention has been illustrated and described with respect to the preferred embodiments, the present invention is not limited thereto. It will be understood by those skilled in the art that various changes and modifications may be made without departing from the scope of the invention as defined in the following claims.

What is claimed is:

1. A method for optimizing database queries, comprising:
searching a subquery within a query;
analyzing the searched subquery to identify a candidate of a scalar subquery;
analyzing the candidate scalar subquery to identify a candidate of a correlated scalar subquery; and
transforming the query having the candidate correlated scalar subquery into a query of a quasi-JOIN depending on a result type of the candidate correlated scalar subquery.

2. The method of claim 1, wherein said analyzing the searched subquery comprises:
analyzing whether the searched subquery is written along with a comparison operator while being included in WHERE clause to identify the searched subquery as the candidate scalar subquery.

3. The method of claim 1, wherein said analyzing the searched subquery includes:
analyzing whether the searched subquery is included in SELECT clause to identify the searched subquery as the candidate scalar subquery.

4. The method of claim 1, wherein said analyzing the candidate scalar subquery comprises:
analyzing whether the candidate scalar subquery uses a column included in a table of the main query to identify the candidate scalar subquery as the candidate correlated scalar subquery.

5. The method of claim 1, wherein said transforming the query having the candidate correlated scalar subquery into a query of a quasi-JOIN includes:
performing UNNEST on the query having the candidate correlated scalar subquery to create a query of AGGREGATION INNER/OUTER JOIN when the candidate correlated scalar subquery takes a type of returning a result of AGGREGATION.

6. The method of claim 1, wherein said transforming the query having the candidate correlated scalar subquery into a query of a quasi-JOIN includes:
performing UNNEST on the query having the candidate correlated scalar subquery to create a query of MAX1ROW INNER/OUTER JOIN when the candidate correlated scalar subquery takes a type of returning one column value.

7. The method of claim 5, wherein the AGGREGATION INNER/OUTER JOIN functions to perform JOIN on the rows of the correlated scalar subquery with the rows of the main query and AGGREGATE on the joined rows and returns a result of the joined rows of the main query and aggregation value thereof.

8. The method of claim 6, wherein the MAX1ROW INNER/OUTER JOIN functions to perform JOIN on the row of the correlated scalar subquery with the rows of the main query, raises Error when the number of the joined rows of the subquery is two or more and returns a result of the row of the main query and the joined row of the subquery.

9. The method of claim 1, wherein the quasi-JOIN is implemented by join algorithms having HASH JOIN, MERGE JOIN and NESTED LOOP JOIN.

10. A query compiler, comprising:
a parser configured to parse a query provided to the query compiler;
a query rewriter configured to analyze the parsed query to identify a correlated scalar subquery, and transform the query having the identified correlated scalar subquery into a query of a quasi-JOIN according to a result type of the identified correlated scalar subquery; and
a query optimizer configured to make a plurality of execution plans from the transformed query of a quasi-JOIN using statistical information, and select a query execution plan having a minimum cost among the plurality of execution plans.

11. The query compiler of claim 10, wherein the query rewriter identifies a scalar subquery included in SELECT clause as the correlated scalar subquery, and
wherein the scalar subquery is a subquery written along with a comparison operator in the subquery while being included in WHERE clause.

12. The query compiler of claim 10, wherein the query rewriter identifies a scalar subquery using a column included in a table of a main query as the correlated scalar subquery.

13. The query compiler of claim 10, wherein the query rewriter is configured to perform UNNEST on the query having the correlated scalar subquery to create a query of AGGREGATION INNER/OUTER JOIN when the correlated scalar subquery takes a type of returning a result of AGGREGATION.

14. The query compiler of claim 10, wherein the query rewriter is configured to perform UNNEST on the query having the correlated scalar subquery to create a query of MAX1ROW INNER/OUTER JOIN when the correlated scalar subquery takes a type of returning one column value.

15. The query compiler of claim 13, wherein the AGGREGATION INNER/OUTER JOIN functions to perform JOIN on the rows of the correlated scalar subquery with the rows of a main query and AGGREGATE on the joined rows and returns a result of the joined rows of the main query and aggregation value thereof.

16. The query compiler of claim 14, wherein the MAX1ROW INNER/OUTER JOIN functions to perform JOIN on the row of the correlated scalar subquery with the rows of a main query, raises Error when the number of joined rows of the subquery is two or more and returns a result of the row of the main query and the joined row of the subquery.

17. The query compiler of claim 10, wherein the quasi-JOIN is implemented by join algorithms having HASH JOIN, MERGE JOIN and NESTED LOOP JOIN.

18. A method for optimizing database queries, the method comprising:
analyzing a query to identify INLINE VIEW; and
transforming the query having the identified INLINE VIEW into a query of AGGREGATION INNER/OUTER JOIN when a main table and the result of INLINE VIEW are joined at N:1 or 1:1,
wherein the AGGREGATION INNER/OUTER JOIN functions to perform JOIN on the rows of the result of INLINE without AGGREGATION, AGGREGATE on the joined rows and returns a result of the joined rows of the main table and aggregation value thereof.

19. A method for optimizing database queries, the method comprising:
analyzing a query to identify GROUP BY with AGGREGATION; and
when JOIN is below the GROUP BY with AGGREGATION, all of the key columns in a main table is used as key(s) of GROUP BY, and columns in other table do not participate as a key of GROUP BY, transforming the query having the identified GROUP BY with AGGREGATION into a query of AGGREGATION INNER/OUTER JOIN,
wherein the AGGREGATION INNER/OUTER JOIN functions to perform JOIN on the rows of the other table, AGGREGATE on the joined rows and returns a result of the joined rows of the main table and aggregation value thereof.
